(19) United States
(12) Patent Application Publication
(10) Pub. No.: US 2009/0042761 A1
(43) Pub. Date: Feb. 12, 2009

(54) SOLUTION AND METHOD FOR CLEANING AND RESTORATION OF HEADLIGHT LENSES

(76) Inventors: Dean Zeisbrich, Roseville, CA (US); Teresa C. Estrada, Roseville, CA (US)

Correspondence Address: SCHNECK & SCHNECK, P.O. BOX 2-E, SAN JOSE, CA, 95109-0005, US

(21) Appl. No.: 12/172,094

(22) Filed: Jul. 11, 2008

Related U.S. Application Data
(60) Provisional application No. 60/949,197, filed on Jul. 11, 2007.

(51) Int. Cl. C11D 3/26

(52) U.S. Cl. 510/163

(57) ABSTRACT

A solution for cleaning plastic headlight covers that includes an oily acid, a surfactant, a citrus turpene and hard nanoparticles of sapphire and diamond. Principal ingredients are carried by commercial windshield cleaning solution or in water.

### PRIORITY CLAIM

This application claims priority from U.S. provisional application serial no. 60/949,197 filed Jul. 11, 2007 by Dean Zeisbrich et al. for “Solution and Method for Cleaning and Restoration of Plastic Composite Headlight Material”.

### TECHNICAL FIELD

The present invention relates to a solution and method for cleaning and restoration of plastic material and more specifically cleaning and restoration of plastic headlight lenses used in vehicles, such as the lens covers for headlights and taillights of automobiles, motorcycles, trucks, and other motor vehicles.

### BACKGROUND

Plastic materials are currently in widespread use for a number of products having exposure to the outside environment. A number of the properties of plastic has resulted in their widespread use. These advantages include the fact that plastics are generally inexpensive, transparent or light transmissive, or light weight, or relatively easy to mold and shape, and may be colored to allow use of an indicator light that would be seen as having a selected color. For these reasons the plastic materials have been widely adopted in the motor vehicle industry, including their use as lens covers secured over headlights and taillights.

Although in widespread use, plastic headlights are subject to unique and demanding environmental and physical conditions. Although plastic and polycarbonate lenses do suffer as a result of UV exposure, that UV exposure is not properly characterized by the yellowing that both industry and the public assume to be plastic failure. This misconception is commonly held for a number of reasons. One reason is that many people have tried to clean their headlights with conventional methods or cleaners and met with little or no success. The actual damage suffered by the lens due to UV exposure is primarily crazing of the surface of the lens. Polycarbonate, the primary material of headlight lenses, is well known for its expansive nature and its tendency to craze from exposure to UV light and temperature differences. This shortcoming of polycarbonate is further exasperated by the extremely hot conditions created by modern headlamps within the headlight structure.

Further compromising the lens is the fact that because of its extremely tough nature and tremendous resilience to impact, manufacturers have been able to build lenses that are thin and lightweight, while at the same time meeting the impact resistance requirements of the Department of Transportation. Unfortunately the thinness of these lenses has compromised their ability to resist expansion under heated conditions leading to crazing and providing the foothold for the initial buildup on the lens. Surface temperatures of a modern headlight lens, when running daylight, they can easily reach temperatures in excess of 150 degrees. These temperatures also give rise to another unique condition that plastic headlight lens are subjected to where the surface of the lens serves as an evaporative surface for water and humidity in the air and any other potential contaminants that are evaporated leaving the solids on the surface of the lens and in the opened crazed lens surface. These contaminants can include hydrocarbons, asphaltic content from the roadway, and mineral deposits from water, all of which find a foothold in the microscopically crazed surface of the lens. The deposits form in successive and initially very thin layers which are nearly undetectable by the naked eye until such a time as the accumulating deposits become larger and are more rapidly accumulated on the roughened profile below. Unfortunately by the time these contaminants become concentrated enough as to give hold to larger and more easily formed particulate/contaminants as to be visible to the naked eye the problem is well beyond the practical use of conventional waxes and cleaners the likes of which can at best remove some yellowing but leave behind the true root of the problem, the mineral layer and leave the lens subject to a rapid re-yellowing in some cases the re-yellowing is worse than that which was partially removed. These visible effects vary and can take up to 3 years to become visible.

Industry standard consists of several abrasive and/or coating processes that have been stated and are designed to remove the aforementioned and improperly characterized UV-damaged plastic in an attempt to reveal an undamaged clear surface. These methods are less efficient from a standpoint of time effectiveness, and continued serviceability of the lens. Further and more often than not, these methods serve to exasperate the condition that began in the headlight, a profile on the lens that is not smooth and is subject to future and more easily established build-ups. In addition, a common method of restoration involves a sanding and re-coating of the lens with any number of acrylic, lacquer, or other coating which is only a temporary fix as the build-up will establish itself on the coating either before or after the failure of that coating. It is best stated that industry and common misconception of the actual causes of the yellowed headlights, has led to their longstanding lack of proper maintenance as the cleaners above stated by manufacturer and the like will not remove the mineral deposits which are the root cause for the tremendous fouling of the lens leading to safety concerns and aesthetically unattractiveness.

It is an object to provide an alternative vehicle light lens cleaning product that is relatively inexpensive, provides rapid results, and can be used by unskilled users.

### SUMMARY

The invention is a vehicle lens cover cleaning solution containing an aqueous solution of urea, minimum 30% by volume, with buffer to between 2 and 6 pH in combination with petroleum distillate of between 10-20% by volume. Nanoparticles having a size of 0.05 to 1.0 micron sapphire, one-eighth pound per gallon, are dispersed in 2-5% surfactant by volume.

### DETAILED DESCRIPTION

The present solution and method remove build-up of contaminants on the surface of plastic resulting in a much more optically clear lens cover and removal of mineral deposits. This improves both the appearance of the lens and the safety of the lens cover. The resulting surface is very smooth and resistant to future build-up of contaminants. The results are achieved without the use of tools or sandpaper, buffers, or other abrasion devices. The improved appearance of the cleaned plastic may be achieved in five minutes or less per lens cover, depending on humidity and climate conditions and lens condition.

The plastic lens covers are generally made of polycarbonate. The lenses are marred by two general types of adherent material. The first is mineral deposits, such as calcium or other minerals. These form tenacious insoluble buildup on the surface of the lens. The other is road grime, made up of dirt and hydrocarbon residues. The presence of the grime makes the removal of the mineral deposits much more difficult.

The present invention has found that a combination of a surfactant, a solvent, and a detergent is not sufficient to clean discolored polycarbonate lenses well as they do not remove mineral buildup on lens. Two additional components are needed:
1. Hard nanoparticles such as diamond and sapphire particles. For the purposes of this invention, nanoparticles means 25 microns to submicron particle size. While the exact mechanism is not understood of action of these particles, it is believed that the nanoparticles act as a physical surfactant. Surfactants and detergents are believed to adhere to the nanoparticles, which penetrate the grime on the lens. In addition, even without scrubbing or abrasion, the mere physical application of the solution containing particles of this specified size and hardness (of the hardness of a sapphire nanoparticle) is believed to cut into the grim and aid in bringing solvents and detergents through the grim to the adherent mineral deposits.
2. A hyper concentrated solution of urea, that will rapidly crystallize on the lens surface. The formation of this crystal is believed to draw into its formation the liberated contaminants from the lens via an acid reaction resulting in precipitate and a salt formation. The urea also acts as an astringent, removing water and bringing the nanoparticles into contact with the lens contaminants.

The nanoparticles and hyper concentrated urea are added to standard cleaning solutions, i.e. solutions containing a solvent, a surfactant, and a detergent. These components dissolve grime and loosen the material solids on the surface of the lens. The citrus (and potentially other) solvents solubilize hydrocarbon grime contaminants that are both under the mineral build-up and inclusions within the mineral build-up. Further the surfactants (and potentially additional astringents) connect the nanoparticles to very small pits and crevices within the plastic material. As the contaminants are liberated from the surface of the lens, astringent components draw out the moisture and form a crystalline structure which has inclusions of nanoparticles which are hard, sharp, and abrasive. These abrasive particles serve to break up oxidized mineral contaminants on the lens surface. Rubbing off of the crystallized solution from the lens causes a highly efficient abrasion of the lens restoring a nearly new appearance to the lens.

The present solution may be sold as a kit containing a pre-soaked applicator wrapped in plastic bottle and/or spray/foam. This would also include a pair of latex gloves to prevent exposure to the nano particles. In one embodiment the components of the solution are as follows:

### EXAMPLE SOLUTION 1

1) Urea (Hyper Concentrated solution) 30%-50%
2) Citrus Terpene, Terpenoid or other citrus oil product 2%-7% by volume
3) Acetic Acid 0.4-2.5 in solution PH (CAS 64-19-7)
4) Citric Acid 0.4-2.5 in solution PH (CAS 77-92-9)
5) Sapphire nano particles (particle size 0.05-0.3 & 1 micron) 1%-5% by volume
6) Surfactant 1%-5% by volume
7) Rinse Agent 1%-5% by volume
8) Diamond nano particles (800 mesh) 0.05-0.5% by volume
9) Silica 5%-7% by weight
10) Sodium Hyperchloride (Lye) 1%-3% by volume
11) Ammonia Bifluoride Detergents 2%-10% by volume
12) Commercially Available Windshield Cleaner Solution as remainder, or water.
   In addition to the above components, there are a number of possible additions and alternates to the above solution including:
   Fragrance
   Bittering Agent (to prevent accidental ingestion)
   Gelling Agent
   Colorant

### EXAMPLE 2

Per 500 cc container, approximately ±5% of the following:
water—remainder
100 cc of commercially available windshield wiper fluid
80 cc of commercially available lemon oil w/petroleum distillate
230 ml of urea crystal (CAS 57-13-6)
   Shake mixture—Endothermic reaction occurs
40 cc of ammonium bifluoride detergent (commercially available)
20 cc of acetic acid (CAS 64-19-7)
20 cc of citric acid (CAS 77-92-9)
60 cc of silica
5 dry karat wt. of 800 mesh diamond powder
2 dry oz. of 0.05 micron sapphire powder
2 dry oz. of 0.03 micron sapphire powder
2 dry oz. of 1 micron sapphire powder pH range between 3.0-4.0

### EXAMPLE SOLUTION 3

| Component | Amount/Gallon | |
|---|---|---|
| Urea | 1200-1500 | g. |
| Citric Acid | 200-300 | g. |
| EDTA | 250-300 | g. |
| Sodium Hydroxide | 200-300 gr to adjust | |
| | pH range to 3-5.5 | |
| Hydrogen Peroxide | 32-48 ounces | |
| | (3% solution in water) | |
| Isopropyl Alcohol | 32-48 ounces | |
| | (91% solution in water) | |
| ZEP (TM) organic acid concrete remover | 350-450 gm by wt. | |
| Hexane or asphaltic distillate | 32-48 | oz. |
| Sulfate of ammonia | 100-200 | g. |
| Sodium hydroxide | 150 | g. |
| .05 micron sapphire | ⅛ to ¼ | |
| Citric turpene | 250-300 | ml. |

Commercial windshield wiper fluid to fill gallon or water.
pH to between 3.5 and 4.5

### EXAMPLE SOLUTION 4

| | | |
|---|---|---|
| hydrogen peroxide | 1.5 | quarts |
| windshield wiper fluid | 0.5 | quarts |
| urea crystals | 1500-2000 | grams |
| citric acid | 300-350 | grams |
| citric turpene degreaser | 25-300 | ml |
| lemon oil cleaner with petroleum distillates | 50-100 | ml |
| ammonium biforide detergents | 250-300 | ml |
| 1 micro aluminum particles | ⅛ | pound |
| 1 micron sapphire particles | ⅛ | pound |
| .05 micron sapphire particles | ⅛ | pound |
| .3 micron sapphire particles | ⅛ | pound |
| organic acid | 300-400 | ml |

water or preferably commercial windshield wiper fluid to fill one gallon
adjust pH to 2.75 to 3.5 with optimal pH at 3.

In any of these formulas, a detergent, a solvent, acids and bases, and a surfactant (some from commercial products) are combined with concentrated urea and nanoparticles. A number of different formulations have been tried. Most were acid solutions, although this is not thought to be essential. The specific pH may be in the range of 2.5-6.0 and be heavily buffered. The time and extent of application of these formulas will depend upon the condition of the lens to which the formulas are applied. The formulas will restore any headlight lens.

We claim:

1. A vehicle lens cover cleaning solution comprising,
at least 30% hyperconcentrated solution of urea, by volume;
at least 2% organic solvent, by volume; and
at least 0.5% weight/volume sapphire or aluminum nanoparticles, all in a commercial windshield wiper solution or water.

2. The cleaning solution of claim 1, including
hyperconcentrated solution of urea at 30% by volume;
a citrus terpene, terpenoid, or other citrus oil product at 2%-7% by volume;
nanoparticles, at least some of which are less than a micron in size, at 1-5% by volume;
a surfactant at 1%-5% by volume.

3. The cleaning solution of claim 1, wherein the nanoparticles include sapphire nanoparticles.

4. The cleaning solution of claim 1, wherein the nanoparticles include some particles less than 1 micron in size.

5. A vehicle lens cover cleaning solution comprising,
An aqueous solution of urea, minimum 30% by volume, with buffer to between 2 and 6 pH in combination with petroleum distillate of between 10-20% by volume and 0.05 to 1.0 micron sapphire nanoparticles, one-eighth pound per gallon, and with 2-5% surfactant by volume.
